(19) United States
(12) Patent Application Publication
(10) Pub. No.: US 2015/0206256 A1
(43) Pub. Date: Jul. 23, 2015

(54) SYSTEMS AND METHODS FOR PROVIDING DYNAMIC UTILITY CONSUMPTION RATINGS

(71) Applicant: General Electric Company, Schenectady, NY (US)

(72) Inventors: Jiyuan Fan, Atlanta, GA (US); Jing Chen, Atlanta, GA (US); Hua Fan, Atlanta, GA (US)

(73) Assignee: General Electric Company, Schenectady, NY (US)

(21) Appl. No.: 14/161,385

(22) Filed: Jan. 22, 2014

(51) Int. Cl. G06Q 50/06

(52) U.S. Cl. CPC G06Q 50/06

(57) ABSTRACT

A system includes a utility analytics system. The utility analytics system includes a memory configured to store a utility rating scheme system relating to consumption pricing of a utility, and a processor communicatively coupled to the memory and configured to execute the utility rating scheme system for receiving an indication corresponding to a consumption of the utility, and deriving a dynamic utility rating scheme based at least in part on one or more cost indicators associated with a production of the utility or an operation of a grid configured to deliver the utility. The dynamic utility rating scheme comprises a cost-based pricing mechanism to adjust the pricing or the consumption of the utility.

### BACKGROUND

The invention relates generally to utility delivery and service infrastructure, and more specifically to methods and systems for providing dynamic utility consumption ratings for end users of a utility service.

Certain energy infrastructure, such as electric power transmission and distribution grids, may include a variety of systems and components with sensors and detection devices that detect and analyze energy and/or other utility data. Certain associations with the energy infrastructure may include contracts, service level agreements, and the like, detailing capitalization, cost, and revenues for the energy infrastructure. A practice of many energy and/or other utility providers may be to provide flat rate pricing to consumers. Unfortunately, the flat rate pricing may not reflect certain energy costs variations, thus resulting in a disconnection between the costs of energy generation and delivery, for example, and the actual costs that the consumers pay. It may be useful to provide methods to improve energy rate pricing.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

A system includes a utility analytics system. The utility analytics system includes a memory configured to store a utility rating scheme system relating to consumption pricing of a utility, and a processor communicatively coupled to the memory and configured to execute the utility rating scheme system for receiving an indication corresponding to a consumption of the utility, and deriving a dynamic utility rating scheme based at least in part on one or more cost indicators associated with a production of the utility or an operation of a grid configured to deliver the utility. The dynamic utility rating scheme comprises a cost-based pricing mechanism to adjust the pricing or the consumption of the utility.

A non-transitory computer-readable medium having code stored thereon, the code includes instructions to receive a first indication corresponding to a pricing of a utility, to receive a second indication corresponding to a consumption of a utility; and to derive a dynamic utility rating scheme based at least in part on one or more cost indicators associated with a production of the utility or an operation of a grid configured to deliver the utility. The dynamic utility rating scheme comprises a cost-based pricing mechanism to adjust the pricing or the consumption of the utility.

A system includes a memory configured to store an energy pricing scheme system relating to consumption pricing of electric power, and a processor communicatively coupled to the memory and configured to execute the energy pricing scheme system to derive a dynamic energy pricing scheme based at least in part on one or more cost effectors associated with a generation of the electric power or an operation of an electric power grid configured to deliver the electric power to an end user. The dynamic energy pricing scheme includes a cost-based pricing implementation for consumption of the electric power.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an embodiment of an energy generation, transmission, and distribution infrastructure system;

FIG. 2 is a block diagram of an embodiment of a utility analytics system included in the system of FIG. 1, in accordance with present embodiments;

FIG. 3 illustrates chart diagrams of comparisons of a flat rating scheme, a time-of-use rating scheme, and a dynamic rating scheme, in accordance with present embodiments; and

FIG. 4 is a flowchart illustrating an embodiment of a process suitable for providing dynamic utility consumption ratings, in accordance with present embodiments.

### DETAILED DESCRIPTION

One or more specific embodiments of the invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the invention, the articles “a,” “an,” “the,” and “said” are intended to mean that there are one or more of the elements. The terms “comprising,” “including,” and “having” are intended to be inclusive and mean that there may be additional elements other than the listed elements.

Present embodiments relate to a utility analytics system that may derive and/or store a cost-reflective dynamic utility rating scheme, in which a utility provider can offer as a cost-effective option to consumers in addition to, or in the place of the existing utility rating and/or pricing schemes such as, flat rating schemes and/or time-of-use (TOU) rating schemes. The dynamic utility rating scheme may account and/or compensate for variable costs in production and delivery of the utility, and, thus, provide the consumer with the best possible pricing and/or rating over, for example, one complete billing cycle (e.g., one month). Specifically, the utility analytics system may derive a number of utility pricing and/or rating schemes to be used by the utility provider to provide customers with multiple pricing and/or rating schemes. The derived pricing and/or rating schemes may include at least one scheme (e.g., flat rating and/or pricing scheme) that may be used as a base scheme (e.g., a reference scheme that may not provide any flexibility to the consumers), while the derived dynamic rating schemes and/or TOU rating schemes may provide additional and/or alternative pricing and/or rating schemes, thus allowing the utility provider and/or the consumers to track the most efficient and cost-effective pricing and/or rating scheme. As used herein “utility” may refer to a service such as electricity, gas, or water that may be provided to a consumer by a utility provider (e.g., electricity utility provider, gas utility provider, water utility provider, and so forth) for use by the consumer. Moreover, the techniques described herein may not be limited to electricity systems, but may also be extended to any utility systems, such as gas systems, water systems, sewage systems, aeration systems, and the like.

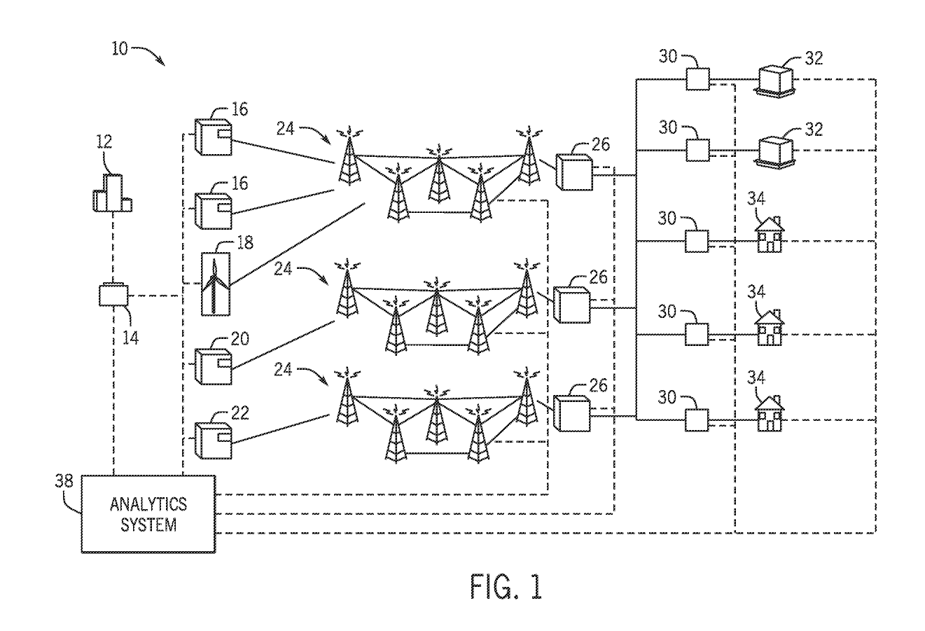

With the foregoing in mind, it may be useful to describe an embodiment of an infrastructure, such as an example energy grid system 10 illustrated in FIG. 1. It should again be noted that the systems and methods described herein may apply to a variety of infrastructures, including but not limited to power distribution infrastructures, gas delivery infrastructures, and various fluid (e.g., water) delivery infrastructures. As depicted, the energy grid system 10 may include one or more utility providers 12. The utility provider 12 may provide for oversight operations of the energy grid system 10. For example, utility control centers 14 may monitor and direct power produced by one or more power generation stations 16 and alternative utility generation stations 18, 20, and 22. The power generation stations 16 may include conventional power generation stations, such as power generation stations using gas, coal, biomass, and other carbonaceous products for fuel. The alternative utility generation station 18 may include power generation stations using solar power, wind power, hydroelectric power, geothermal power, and other alternative sources of power (e.g., renewable energy) to produce electricity. Other alternative utility generation stations may include a water power producing plant 20 and geothermal power producing plant 22. For example, water power producing plants 20 may provide for hydroelectric power generation, and geothermal power producing plants 22 may provide for geothermal power generation.

The power generated by the power generation stations 16, 18, 20, and 22 may be transmitted through a power transmission grid 24. The power transmission grid 24 may cover a broad geographic region or regions, such as one or more municipalities, states, or countries. The transmission grid 24 may also be a single phase alternating current (AC) system, but most generally may be a three-phase AC current system. As depicted, the power transmission grid 24 may include a series of towers to support a series of overhead electrical conductors in various configurations. For example, extreme high voltage (EHV) conductors may be arranged in a three conductor bundle, having a conductor for each of three phases. The power transmission grid 24 may support nominal system voltages in the ranges of 110 kilovolts (kV) to 765 kilovolts (kV) or more. In the depicted embodiment, the power transmission grid 24 may be electrically coupled to a power distribution substation and grid 26. The power distribution substation and grid 26 may include transformers to transform the voltage of the incoming power from a transmission voltage (e.g., 765 kV, 500 kV, 345 kV, or 138 kV) to primary (e.g., 13.8 kV or 4160V) and secondary (e.g., 480V, 240V, or 120V) distribution voltages. For example, industrial electric power consumers (e.g., production plants) may use a primary distribution voltage of 13.8 kV, while power delivered to commercial and residential consumers may be in the secondary distribution voltage range of 120V to 480V.

As again depicted in FIG. 1, the power transmission grid 24 and power distribution substation and grid 26 may be part of the energy grid system 10. Accordingly, the power transmission grid 24 and power distribution substation 26 may include various digital and automated technologies to control power electronic equipment such as generators, switches, circuit breakers, reclosers, and so forth. In certain embodiments, the power transmission grid 24 and power distribution substation and grid 26 may also deliver power and communicate data such as changes in electric load demand to a meter 30.

In certain embodiments, the meter 30 may be an Advanced Metering Infrastructure (AMI) meter used to collect, measure, and analyze electric power usage and/or generation. For example, electric utilities may report to consumers their usage and/or generation per kilowatt-hour (kWh) for billing and/or crediting purposes. The meter 30 may be electrically and communicatively coupled to one or more of the components of the system 10, including the power transmission grids 24, power distribution substation and grid 26, and a commercial and/or industrial consumer 32 and residential consumer 34. Additionally, the meter 30 may enable two-way communication between commercial and residential consumers 32, 34 and the utility control center 14, providing for a link between consumer behavior and electric power usage and/or generation. For example, the meter 30 may track and account for pre-paid energy usage and/or energy used before payment As noted above, electric power may also be generated by the consumers (e.g., commercial consumers 32, residential consumers 34). For example, the consumers 32, 34 may interconnect a distributed generation (DG) resource (e.g., solar panels or wind turbines) to generate and deliver power to the grid 26. As further illustrated, communicatively coupled to components (e.g., utility control center 14, power generation stations 16, 18, 20, and 22, transmission grid 24, substation and grid 26, meter 30, and so forth) of the system 10 may be an analytics system 38.

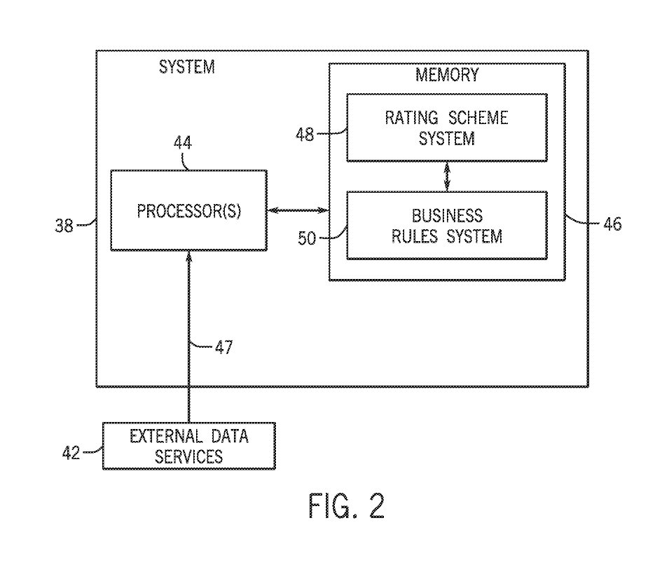

FIG. 2 is a block diagram of an embodiment of the utility analytics system 38. As illustrated, the utility analytics system 38 may include one or more processors 44, a memory 46 (e.g., storage), input/output (I/O) ports (e.g., one or more network interfaces 47), an operating system, software applications, and so forth, useful in implementing the techniques described herein. Particularly, the utility analytics system 38 may include code or instructions stored in a tangible non-transitory machine-readable medium (e.g., the memory 46 and/or storage) and executed, for example, by the one or more processors 44 that may be included in the analytics system 38. Additionally, the utility analytics system 38 may include a network interface 47, which may allow communication within the system 10 via a personal area network (PAN) (e.g., NFC), a local area network (LAN) (e.g., Wi-Fi), a wide area network (WAN) (e.g., 3G or LTE), a physical connection (e.g., an Ethernet connection, power line communication (PLC)), and/or the like.

In certain embodiments, as will be discussed in further detail below, the utility analytics system 38 may be used to derive and store data related to certain business parameters such as billed and unbilled energy, billing cycle data, energy rates, dynamic rating and billing schemes, and so forth. Accordingly, the utility analytics system 38 may receive continuous (and/or predetermined timed) updates of the energy usage of the consumers 32 and 34, and report such information to the utility provider 12 and/or utility control center 14. Indeed, the utility analytics system 38 may receive (e.g., via the one or more processors 44) and store (e.g., to the memory 46) the cost of energy, the amount of energy used at the use end point (e.g., commercial buildings, residences) and/or billed to the consumers 32, 34, the amount of energy unbilled (e.g., energy used by the consumers 32, 34 or lost over a billing cycle but has not yet been billed), time-of-use (TOU) data, and usage and load profiles, and may derive one or more billing and/or energy rating schemes (e.g., flat rating scheme, TOU rating scheme, dynamic rating, and so forth) based on consumer 32, 34 usage data collected.

As further illustrated in FIG. 2, the utility analytics system 38 may receive data from external data services 42 communicatively coupled to the one or more processors 44 of the utility analytics system 38. The one or more processors 44 may transfer the received data between systems of the memory 46 internal to the utility analytics system 38. This data may include energy and business-related data, which in some embodiments, may be derived and/or calculated based on data received from the transmission grid 24, distribution substation and grid 26, the meters 30, and so forth. The external data services 42 may include systems useful in exchanging data with components (e.g., generation stations 16, 18, 20, and 22, grids 24 and 26, meter 30, and so forth) external to the analytics system 38. For example, the external data services 42 may include systems such as an Outage Management System (OMS), a Distribution Management System (DMS), a Geographic Information System (GIS), Customer Information System (CIS), a Meter Data Management (MDM), an Advanced Metering Infrastructure (AMI), an Automatic Meter Reading (AMR), a Meter Data Repository (MDR), or other similar external systems. As will be further appreciated, the data received via the OMS, DMS, GIS, CIS, MDM, MDR, and AMI systems may be input to internal systems of the utility analytics system 38, such as an energy rating scheme system 48 and business rules system 50 stored, for example, in the memory 46 and executed by the one or more processor(s) 44 of the utility analytics system 38.

In certain embodiments, the energy rating scheme system 48 (e.g., executed via the processor 44) may be a software system and/or a combination of software and hardware that may be used to derive and/or calculate dynamic energy rating and/or pricing schemes for consumers 32, 34. For example, in certain embodiments, the energy rating scheme system 48 may derive a number of energy billing rating schemes such as a flat rating scheme, TOU rating scheme, or a dynamic scheme. Specifically, the energy rating scheme system 48 (e.g., executed via the processor 44) may be used to calculate the dynamic energy billing ratings for a specific billing cycle (e.g., hourly, daily, monthly, quarterly, and/or annually), and may report to consumers 32, 34 their usage per kWh for billing purposes. For example, the flat rating scheme may include a flat (e.g., commercially inactive) billing rate (e.g., price per kWh) charged to consumers 32, 34 irrespective of variations in, for example, generation and delivery costs, energy demand, TOU data, seasonal changes, weather variations, business incentives and/or business disincentives, and so forth.

Conversely, the TOU rating scheme generated by the energy rating scheme system 48 may include, for example, rates corresponding to an off-peak rate, a near-peak rate, or a peak rate. For example, the off-peak rate may be applied to consumers 32, 34 energy usage during, for example, hours ranging from approximately 10:00 p.m. to approximately 6:00 a.m. Similarly, the near-peak rate may be applied to consumers 32, 34 energy usage during, for example, hours ranging from approximately 6:00 a.m. to approximately 5:00 p.m., while the peak energy rate may be applied, for example, during hours ranging from approximately 5:00 p.m. to approximately 10:00 p.m. In other embodiments, the TOU rating scheme may also take into account the date and time that the meter 30 is read, holidays and weekends, and so forth.

However, when providing only flat rating schemes and TOU rating schemes, the energy rating scheme system 48 may not account for real-time energy cost variations such as those resulting from, for example, generation and delivery costs for the utility provider 12, energy demand of the consumers 32, 34, specific TOU data, seasonal changes, infrastructure maintenance, business-related data such as incentives and/or discounts to the consumers 32, 34, and so forth. For example, the real-time cost of energy generation and delivery, and thus consumption of energy by the consumers 32, 34, may be affected by the season of the year. For example, energy rates may be generally higher (e.g., due to consumers 32, 34 rising energy demand for cooling systems, and the increase in cost of electric power generation and/or delivery by the utility provider 12) during the latter spring and summer months (e.g., May-September), but much less during the cooler winter months (e.g., October-April). Thus, consumers 32, 34 subject to only a flat rating scheme may not be apt to take advantage of periods of lower cost energy consumption. Similarly, consumers 32, 34 subject to only a TOU rating scheme may not be subject to certain energy cost savings during periods of lower cost energy consumption. This may result in a disconnection between the time-based and/or cost-based expenses of energy generation and/or energy delivery by the utility provider 12, and the actual prices the consumers 32, 34 may be subject to paying. This may further lead to vast inefficiencies, and an improvident use of resources (e.g., financial resources, infrastructure) of both the utility provider 12 and the consumers 32, 34.

Accordingly, in certain embodiments, it may be useful for the energy rating scheme system 48 (e.g., executed via the processor 44) to derive and/or calculate a dynamic rating scheme based on, for example, real-time or near real-time energy and/or business related data. Specifically, the energy rating scheme system 48 (e.g., executed via the processor 44) may derive the dynamic rating scheme based on data received via the OMS, DMS, GIS, CIS, MDM, MDR, and AMI systems along with certain criteria or predetermined rules (e.g., one or more business rules) generated by a business rules system 50 that may be included in the utility analytics system 38. The business rules system 50 may be any system (e.g., software system and/or software application) executed by the one or more processor(s) 44 useful in generating one or more business rules including, for example, financial goals, company policies, legal regulations, and/or similar business (e.g., utility provider 12) operations data that may affect energy ratings and/or consumption pricing.

In certain embodiments, the dynamic rating scheme generated by the energy rating scheme system 48 (e.g., via the processor 44) may be a cost-reflective dynamic pricing scheme that may, in some embodiments, include an aggregate of other rating and/or pricing schemes such as the TOU rating scheme or other time-based and cost-based rating schemes. Specifically, the dynamic rating scheme may account for the variations in costs of energy generation and/or delivery, and may incentivize the consumers 32, 34 to practice more economical and efficient consumption patterns. For example, the consumers 32, 34 may experience certain financial savings by learning to shift energy demand during periods of generally higher energy costs (e.g., peak time periods, summer months, and so forth) to periods of lower energy costs (e.g., off-peak time periods). This information may be provided to the consumers 32, 34 via the dynamic rating scheme generated by the energy rating scheme system 48.

In certain embodiments, the dynamic rating scheme generated by the energy rating scheme system 48 may be provided as merely an option to the consumers 32, 34. For example, at the end of each billing cycle (e.g., monthly billing cycle), the bills of the consumers 32, 34 may be calculated based on each rating scheme (e.g., flat rating scheme, TOU rating scheme, dynamic rating scheme) the consumer 32, 34 elected to participate in. The energy rating scheme system 48 may then calculate the consumers 32, 34 bills according to the rating scheme and/or aggregate of rating schemes that yields the minimum costs (e.g., price per kWh) to the consumers 32, 34. The consumers 32, 34 may then be required to pay only the lesser of the pricing ratings calculated according to the derived rating schemes, and based on a comparison between the consumers' 32, 34 energy consumption patterns and the derived rating scheme. In this way, the consumers 32, 34 may likely pay a lesser value, or at worst, an equal value to what the consumer 32, 34 would pay based only the flat rating scheme and the TOU rating scheme. That is, the dynamic rating scheme generated by the energy rating scheme system 48 may take into account the real-time or near real-time factors (e.g., generation and delivery costs, energy demand, fuel prices, specific TOU data, seasonal changes, weather variations, business-related data such as tax incentives, tax disincentives, energy stock prices, and changing infrastructure maintenance and operating costs, changing regulations and policies, and so forth) that may affect the costs of energy generation and/or delivery, and by extension, the cost of energy consumption by the consumers 32, 34. Moreover, because the dynamic rating scheme may be optional and likely to result in only financial savings (e.g., instead of additional costs) by the consumer 32, 34 and the utility provider 12, the dynamic rating scheme may be implemented by the utility provider 12 under the existing laws and regulations governing the energy costs and consumption.

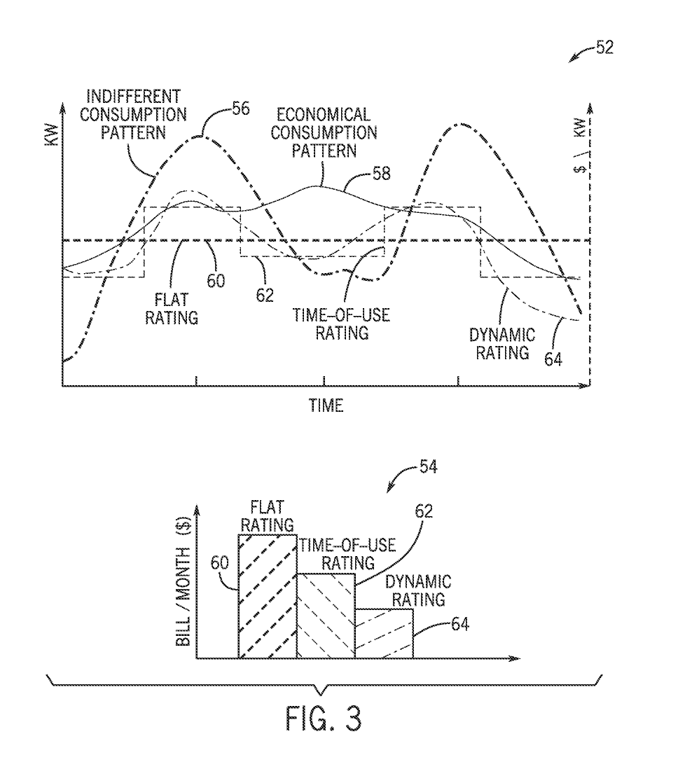

As an example illustration, FIG. 3 depicts a diagram 52 of a consumer's (e.g., consumers 32, 34) energy consumption (e.g., kWh) and cost (e.g., price per kWh) pattern over, for example, one billing cycle (e.g., one month), and a cost comparison diagram 54 of the flat rating scheme, the TOU rating scheme, and the dynamic rating scheme. Specifically, the diagram 52 presents a comparison of a consumer 32, 34 practicing an indifferent energy consumption pattern 56 and a consumer 32, 34 practicing an economical consumption pattern 58 as allowed by providing the dynamic rating scheme. The diagram 52 also illustrates a flat rating scheme plot 60 (e.g., price per kWh), a TOU rating scheme plot 62 (e.g., price per kWh), and a dynamic rating scheme plot 64 (e.g., price per kWh). As depicted, the consumer 32, 34 practicing the indifferent energy consumption pattern 56 may be subject to higher energy costs when, for example, consuming energy during peak demand periods, as well as possibly subject to higher energy costs when consuming energy during off-peak periods. This is illustrated by the high amplitudes (e.g., crests) and low troughs of the consumption pattern 56. As can be seen, when the consumer 32, 34 is subject to the flat rating scheme 60, the consumer 32, 34 may experience some possible cost savings when consuming energy during peak periods, but may also experience higher costs when consuming energy during off-peak periods. Similarly, when the consumer 32, 34 is subject to only a TOU rating scheme 62, the consumer 32, 34 may experience some possible cost savings when consuming energy during peak periods, but may again experience higher costs when consuming energy during off-peak periods.

However, as further illustrated, the dynamic rating scheme 64 may be constantly adjusted to compensate for the various changes in energy consumption costs. Thus, the dynamic rating scheme 64 (e.g., generated by the rating scheme system 48 and executed by the one or more processor(s) 44 of the utility analytics system 38 as discussed with respect to FIG. 2) may be provided by the utility provider 12 to incentivize the consumer 32, 34 to consume energy according to the economical consumption pattern 58. As can be seen, when the consumer 32, 34 is subject to the dynamic rating scheme 64, the consumer 32, 34 may experience cost savings when consuming energy during peak periods, as well as during off-peak periods, as the dynamic rating scheme 64 may reflect real-time or near real-time factors (e.g., generation and delivery costs, energy demand, fuel prices, TOU data, seasonal changes, weather variations, business-related data such as tax incentives, tax disincentives, energy stock prices, and changing infrastructure and operating costs, changing regulations and policies, and so forth) that may adversely impact the cost of energy consumption by the consumers 32, 34. The diagram 54 illustrates the cost comparison between the flat rating scheme 60, the TOU rating scheme 62, and the dynamic rating scheme 64 over, for example, a billing cycle of one month. As illustrated, the dynamic rating scheme 64 may provide significant cost savings (e.g., to the consumers 32, 34, as well as the utility provider 12) as compared to the flat rating scheme 60 and the TOU rating scheme 62 alone.

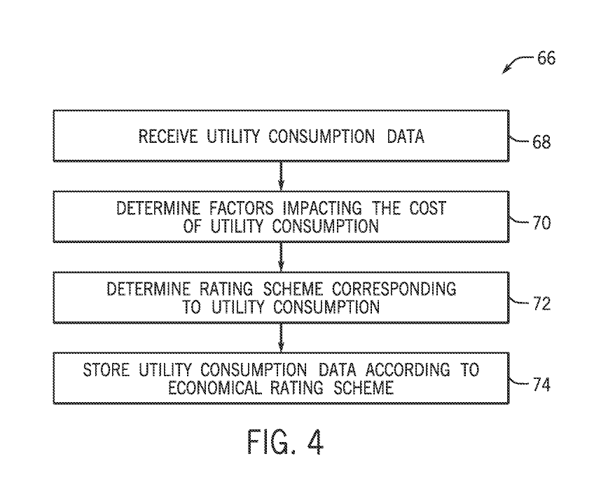

Turning now to FIG. 4, a flow diagram is presented, illustrating an embodiment of a process 66 suitable for calculating and storing utility usage according to a dynamic rating and/or pricing scheme by using, for example, the one or more processor(s) 44 and the memory 46 of the utility analytics system 38 depicted in FIG. 2. Thus, the process 66 may include code or instructions stored in a non-transitory machine-readable medium (e.g., the memory 46) and executed, for example, by the one or more processor(s) 44 included in the utility analytics system 38. The process 66 may begin with the one or more processor(s) 44 receiving (block 68) utility consumption data. For example, as previously discussed, the one or more processor(s) 44 may receive indications from the meters 30 reflecting the utility usage of the consumers 32, 34 over, for example, 15-minute, 30-minute, 45-minute, 60-minute intervals, and/or over a monthly billing cycle. The process 66 may continue with the one or more processor(s) 44 determining (block 70) in real-time or near real-time certain factors impacting the cost of utility consumption. For example, the one or more processor(s) 44 may determine certain utility generation and delivery costs, energy demand, fuel prices, specific TOU data, seasonal changes, weather variations, business-related data such as tax incentives, tax disincentives, energy stock prices, and changing infrastructure and operating costs, changing regulations and policies, and/or other various factors that may adversely impact the utility costs (e.g., pricing) to the consumers 32, 34.

The process 66 may then continue with the utility analytics system 38 determining (block 72) a dynamic rating scheme corresponding to the utility consumption of, for example, the consumers 32, 34 and based on the dynamic factors impacting the cost of utility consumption. For example, the dynamic rating scheme may be a cost-reflective dynamic pricing scheme that may account for the variations in costs of the utility, and may incentivize the consumers 32, 34 to practice more economical and efficient utility consumption patterns. The process 60 may then conclude with the one or more processor(s) 44 storing (block 74) (e.g., to the memory 46) the utility consumption data of the consumers 32, 34 according to the dynamic rating scheme. In certain embodiments, the utility consumption data of the consumers 32, 34 may then be transmitted by the one or more processor(s) 44 to the meter 30 of the consumers 32, 34, or presented to the consumers 32, 34 in a similar manner. In this way, the consumers 32, 34 may likely pay a lesser value, or at worst, an equal value to what the consumer 32, 34 would pay based only the flat rating scheme and the TOU rating scheme. As a result, the dynamic rating scheme may provide cost savings to the consumers 32, 34, as well as the utility provider 12.

Technical effects of the disclosed embodiments relate to a utility analytics system that may derive and/or store a cost-reflective dynamic utility rating scheme, in which a utility provider can offer as a cost-effective option to consumers in addition to, or in the place of the existing utility rating and/or pricing schemes such as, flat rating schemes and/or time-of-use (TOU) rating schemes. The dynamic utility rating scheme may account and/or compensate for variable costs in production and delivery of the utility, and, thus, provide the consumer with the best possible pricing and/or rating over, for example, one complete billing cycle (e.g., one month). Specifically, the utility analytics system may derive a number of utility pricing and/or rating schemes to be used by the utility provider to provide customers with multiple pricing and/or rating schemes. The derived pricing and/or rating schemes may include at least one scheme (e.g., flat rating and/or pricing scheme) that may be used as a base scheme (e.g., a reference scheme that may not provide any flexibility to the consumers), while the derived dynamic rating schemes and/or TOU rating schemes may provide additional and/or alternative pricing and/or rating schemes, thus allowing the utility provider and/or the consumers to track the most efficient and cost-effective pricing and/or rating scheme.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a utility analytics system, comprising:
a memory configured to store a utility rating scheme system relating to consumption pricing of a utility; and
a processor communicatively coupled to the memory and configured to execute the utility rating scheme system, comprising:
receiving an indication corresponding to a consumption of the utility; and
deriving a dynamic utility rating scheme based at least in part on one or more cost indicators associated with a production of the utility or an operation of a grid configured to deliver the utility, wherein the dynamic utility rating scheme comprises a cost-based pricing mechanism to adjust the pricing or the consumption of the utility.

2. The system of claim 1, wherein the one or more cost indicators comprises a utility production cost indicator, a utility delivery cost indicator, a utility consumer demand cost indicator, a seasonal change cost indicator, business-related cost indicator, a regulatory cost indicator, or any combination thereof.

3. The system of claim 1, wherein the processor is configured to derive a flat utility rating scheme and a time-of-use (TOU) utility rating scheme in conjunction with the dynamic utility rating scheme, wherein the flat utility rating scheme comprises a flat consumer price irrespective of the one or more cost indicators, and wherein the TOU rating utility scheme comprises a time-based pricing mechanism to adjust the pricing or the consumption of the utility.

4. The system of claim 3, wherein the processor is configured to compute a consumer bill for the consumption of the utility based on each of the dynamic utility rating scheme, the flat utility rating scheme, and the TOU utility rating scheme.

5. The system of claim 3, wherein the processor is configured to compute a consumer price for the consumption of the utility based on each of the dynamic utility rating scheme, the flat utility rating scheme, and the TOU utility rating scheme, and to compute a consumer bill according to the utility rating scheme that yields a minimum consumer price.

6. The system of claim 5, wherein the dynamic utility rating scheme yields the minimum consumer price.

7. The system of claim 1, wherein the processor is configured to derive the dynamic utility rating scheme with respect to a complete billing cycle.

8. The system of claim 7, wherein the complete billing cycle comprises a billing cycle of approximately one month.

9. The system of claim 1, wherein the dynamic utility rating scheme is configured to provide a possible cost savings to a provider of the utility and to a consumer of the utility.

10. The system of claim 1, wherein the processor is configured to receive the utility consumption indication from an Advanced Metering Infrastructure (AMI), an Outage Management System (OMS), a Distribution Management System (DMS), a Geographic Information System (GIS), a Customer Information System (CIS), a Meter Data Management System (MDM), a Meter Data Repository (MDR), or a combination thereof, and to derive the dynamic utility rating scheme based thereon.

11. A non-transitory computer-readable medium having computer executable code stored thereon, the code comprising instructions to:
receive a first indication corresponding to a pricing of a utility;
receive a second indication corresponding to a consumption of a utility; and
derive a dynamic utility rating scheme based at least in part on one or more cost indicators associated with a production of the utility or an operation of a grid configured to deliver the utility, wherein the dynamic utility rating scheme comprises a cost-based pricing mechanism to adjust the pricing or the consumption of the utility.

12. The non-transitory computer-readable medium of claim 11, wherein the code comprises instructions to derive a flat utility rating scheme and a time-of-use (TOU) utility rating scheme in conjunction with the dynamic rating scheme, wherein the flat utility rating scheme comprises a flat consumer price irrespective of the one or more cost indicators, and wherein the TOU rating utility scheme comprises a time-based pricing mechanism to adjust the pricing or the consumption of the utility.

13. The non-transitory computer-readable medium of claim 12, wherein the code comprises instructions to compute a consumer bill for the consumption of the utility based on each of the dynamic utility rating scheme, the flat utility rating scheme, and the TOU utility rating scheme.

14. The non-transitory computer-readable medium of claim 12, wherein the code comprises instructions to compute a consumer price for the consumption of the utility based on each of the dynamic utility rating scheme, the flat utility rating scheme, and the TOU utility rating scheme, and to compute a consumer bill according to the utility rating scheme that yields a minimum consumer price.

15. The non-transitory computer-readable medium of claim 14, wherein the dynamic utility rating scheme yields the minimum consumer price.

16. The non-transitory computer-readable medium of claim 11, wherein the code comprises instructions to derive the dynamic utility rating scheme with respect to a complete billing cycle.

17. A system, comprising:
a memory configured to store an energy pricing scheme system relating to consumption pricing of electric power; and
a processor communicatively coupled to the memory and configured to execute the energy pricing scheme system to derive a dynamic energy pricing scheme based at least in part on one or more cost effectors associated with a generation of the electric power or an operation of an electric power grid configured to deliver the electric power to an end user, wherein the dynamic energy pricing scheme comprises a cost-based pricing implementation for consumption of the electric power.

18. The system of claim 17, wherein the processor is configured to derive a flat energy pricing scheme and a time-of-use (TOU) energy pricing scheme along with the dynamic energy pricing scheme, wherein the flat energy pricing scheme comprises a flat consumer price irrespective of the one or more cost effectors, and wherein the TOU energy pricing scheme comprises a time-based pricing implementation for the consumption of the electric power.

19. The system of claim 18, wherein the processor is configured to compute a consumer price for the consumption of the electric power based on each of the dynamic energy pricing scheme, the flat energy pricing scheme, and the TOU energy pricing scheme, and to compute a consumer bill according to the energy pricing scheme that yields a minimum consumer price.

20. The system of claim 17, wherein the one or more cost effectors comprises an electric power generation cost effector, an electric power delivery cost effector, an electric power consumer demand cost effector, a seasonal change cost effector, business-related cost effector, a regulatory cost effector, or any combination thereof.
